(19) United States
(12) Patent Application Publication
(10) Pub. No.: US 2013/0085924 A1
(43) Pub. Date: Apr. 4, 2013

(54) INTERACTIVE CREDIT MARKETPLACE SYSTEM AND METHOD

(71) Applicants: Ismail Kursat Colak, New York, NY (US); Jean- Marc Derek Freuler, New York, NY (US)

(72) Inventors: Ismail Kursat Colak, New York, NY (US); Jean- Marc Derek Freuler, New York, NY (US)

(21) Appl. No.: 13/249,690

(22) Filed: Sep. 30, 2011

(51) Int. Cl. G06Q 40/02

(52) U.S. Cl. 705/38

(57) ABSTRACT

The present invention provides an interactive credit marketplace for credit offers, such as trade credit lines. The invention also relates to systems and methods for determining eligibility of a purchaser for particular credit offers and facilitating credit applications between purchasers and suppliers through a multiple-offer display mechanism, as well as for automated, streamlined processing of applications by purchasers for credit deals based on the multiple-offer display mechanism.

### INCORPORATION BY REFERENCE

All documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates generally to an interactive credit marketplace for credit offers, such as trade credit lines, and, more particularly, to systems and methods for determining eligibility of a purchaser for particular credit offers and facilitating credit applications between purchasers and suppliers through a multiple-offer display mechanism, as well as for automated, streamlined processing of applications by purchasers for credit deals based on the multiple-offer display mechanism.

### BACKGROUND OF THE INVENTION

In existing business-to-business trade credit relationships, application for a trade credit line is a bilateral process whereby a purchaser directly or indirectly applies for the trade credit line associated with the transactions of goods and services between the supplier and the purchaser. Evaluation of the applications are either handled internally by the supplier, or outsourced, either in whole or in part, to a third party entity that is responsible for evaluation and monitoring of the trade credit applications, as well as determining the credit terms, including discounts, penalties, net payment terms and extensions.

In existing application processes, purchasers apply to trade credit offers by filling out or electronically submitting an application for credit to a supplier of goods or services. The supplier or the external entity responsible for credit evaluation and screening then decides, based on the submitted information, whether to extend credit to the purchaser; in cases where the purchaser is eligible for trade credit, the amount and payment terms are also generally decided along with the trade credit offer.

With regards to an application for trade credit, existing systems require the purchaser to apply to different trade credit deals separately, despite a significant level of criteria overlap between different trade credit applications.

Moreover, the application process is relatively opaque. Purchasers are unclear about the required eligibility criteria for trade credit lines and their current status in order to be approved for a trade credit offer from a supplier, until the supplier completely evaluates the full trade credit application and decides on the eligibility, along with credit terms.

Existing systems require purchasers to go through a different trade credit application process each time they are applying to a new supplier or group of suppliers for trade credit. Identifying the right contact, receiving the application and applying to each supplier separately becomes an arduous process with material time and labor costs.

Citation or identification of any document in this application is not an admission that such document is available as prior art to the present invention.

### SUMMARY OF THE INVENTION

An automated, centralized trade credit marketplace is required that provides eligibility information to purchaser about a potential trade credit offer from a supplier and streamlines the trade credit application process for purchaser by submitting a single trade credit application to multiple suppliers.

The present invention relates to a method of facilitating the receipt by at least one purchaser of one or more credit offers by at least one supplier, the credit offers being associated with potential transactions involving the associated suppliers providing goods or services, or both, to the at least one purchaser, wherein the method may be implemented by a computer system which may comprise one or more processors operable in executing program code stored on at least one computer readable medium.

In particular, the computer system may receive one or more credit offers associated with each of at least one supplier, wherein each credit offer may comprise credit eligibility criteria specified by the supplier associated with the credit offer and said credit eligibility criteria may comprise at least one criterion that must be satisfied by a purchaser to qualify for the credit offer.

In particular, the computer system may receive respective purchaser-information from each of at least one purchaser, wherein the computer system may be operative in attempting to ensure that the purchaser-information includes sufficient information to compare with all of the credit eligibility criteria of at least one of said credit offers.

Further, the computer system may analyze at least the received purchaser-information and the received credit eligibility criteria to determine for each credit offer which, if any, of the at least one purchaser is eligible for the credit offer.

The computer system may also provide for access by each purchaser to credit offer information that indicates the credit offers for which the purchaser is eligible.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1A is a general illustration of an automated credit eligibility and application platform between a purchaser and a seller, in accordance with some embodiments of the present invention.

FIG. 1B depicts an illustrative computer system operable for implementing an automated credit eligibility and application platform between purchaser and a seller, in accordance with some embodiments of the present invention.

FIG. 2 is a detailed diagram of a computerized method for identifying the purchaser for an eligible credit offer and processing multiple applications made by the purchaser, in accordance with some embodiments of the present invention.

FIG. 3 is a flow chart further illustrating the computerized registration and identity verification process for purchasers, in accordance with some embodiments of the present invention.

FIG. 4 is a flow chart describing the computerized method for purchaser registration and identity verification process on the platform, in accordance with some embodiments of the present invention.

FIG. 5 is a flow chart describing the computerized method for data selection, sorting, ranking and combination process for credit criteria on the platform, in accordance with some embodiments of the present invention.

FIG. 6 is an illustration of the automated decision-mechanism that determines the eligibility of a purchaser in a group of purchasers for a credit offer generated by a supplier, in accordance with some embodiments of the present invention.

FIG. 7 is a schematic representation of the computerized system responsible for primary registration and initial setup for a supplier, in accordance with some embodiments of the present invention.

FIG. 8 is a flow chart illustrating credit offer setup process for the supplier, in accordance with some embodiments of the present invention.

FIG. 9 is an overview of the electronic display module, as submitted by the supplier and viewed by the purchaser, in accordance with some embodiments of the present invention.

FIG. 10 is an illustration of the computerized method that manages the automatic application process for credit offers and post-application transmission, confirmation and feedback mechanism, in accordance with some embodiments of the present invention.

### DETAILED DESCRIPTION OF THE INVENTION

Systems and methods described herein according to some embodiments of the present invention electronically obtain trade credit eligibility criteria from suppliers about their credit offers and automatically display these offers to eligible purchasers, who in turn can apply to these trade credit offers through an online, automated, electronic platform. Moreover, purchasers will automatically receive a notification updating the purchasers about their business credit status and any minimum criteria that need to be met in order to qualify or be eligible for such trade credit offers from suppliers. Such criteria may be directly displayed to purchasers with the consent of the suppliers or these criteria may be statistical data gathered from a pool of purchasers.

As will be further understood from the ensuing description, according to some embodiments, the system in which a trade credit eligibility and display mechanism is set involves a third-party (i.e., an entity independent of both purchaser and seller) interactive trade credit system that (i) receives trade credit eligibility criteria for trade credit offers from suppliers and (ii) displays these offers to eligible purchasers and provides a streamlined trade credit application system for purchasers.

As will also be further understood from the ensuing description, a purchaser's pre-application data registration and initial eligibility criteria collection system ensures that purchaser can be notified on eligibility about offers before having to apply for a credit line to find out about approvals. In alternative embodiments, purchasers may be notified about their eligibility status on a continuous basis before or after an application is complete. Should the purchaser be deemed ineligible for a trade credit offer, the system may notify the purchaser accordingly with the reasons. The notification may include, for example, a required minimum payment performance to past or existing suppliers, minimum required operating history, geographic location, leverage ratio or general financial or operational risk factors that deemed the purchaser ineligible for a trade credit offer. The system also ensures the supplier will receive applications that are pre-screened and eligible for a credit line (e.g., demonstrating a level of sufficiency to fulfill the criteria, terms and conditions required by the supplier to extend credit). As further discussed below, the eligibility criteria may include any type of data about the business, including, for example, its operations, its owners, employees, partners, financial condition, revenue and tax information, current credit status and past credit history, past payment performance, trade references, industry and geographic information.

As also further described below, some embodiments of the present invention may include a display mechanism that, after determining the eligibility status of purchasers for all the credit offers available on the system, displays each purchaser the complete, or based on user preferences, partial universe of all credit offers the purchaser is eligible for. The display mechanism will also provide industry statistics and trends about trade credit offers as well as benchmark tools that allow purchasers to better understand their eligibility for trade credit.

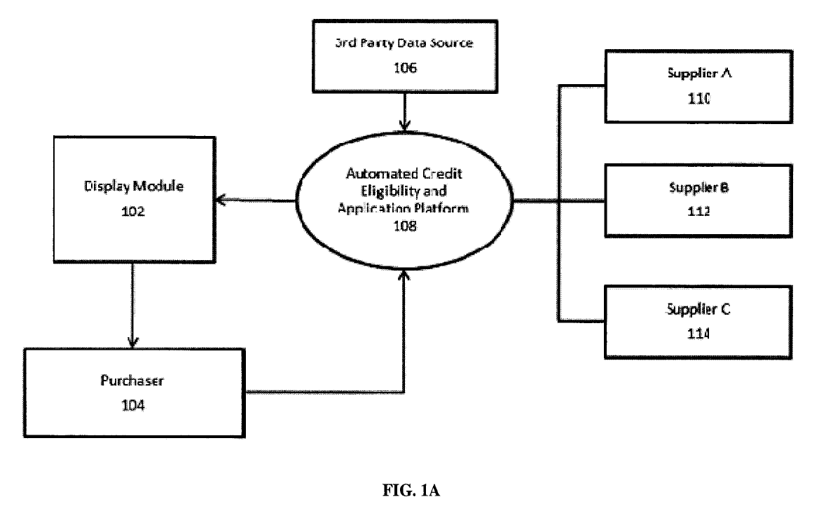

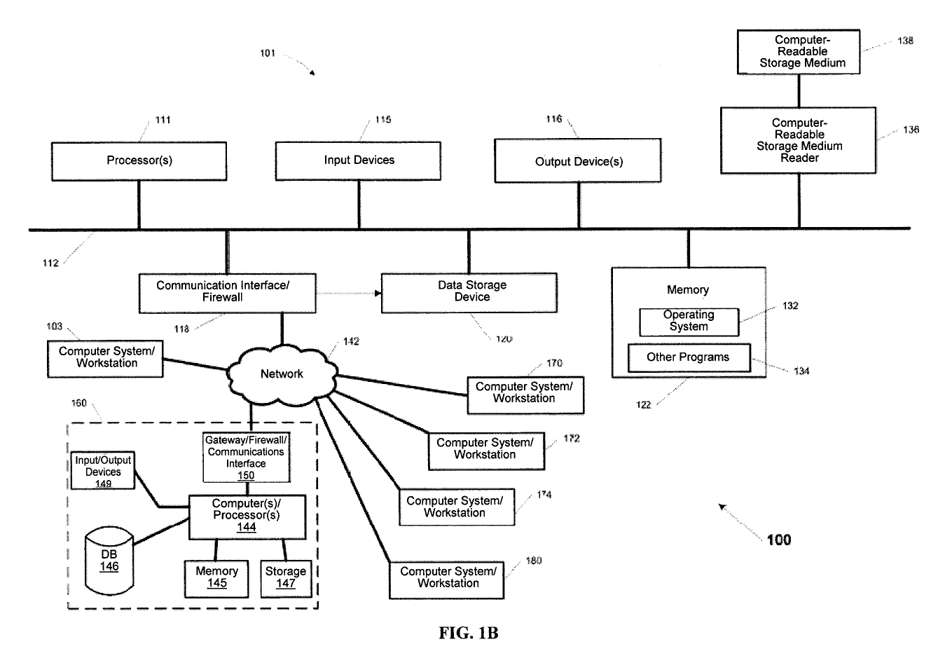

FIG. 1A is a general illustration of an automated credit eligibility and application platform 108 between a purchaser and a seller according to some embodiments of the present invention, where the platform 108 manages the dataflow between suppliers A, B and C, 110, 112 and 114 respectively, and the purchaser 104 through a display module 102 that selectively transmits pre-selected credit offers to the purchaser on the condition that the purchaser fulfils the eligibility criteria for those particular offers. Credit eligibility and application platform 108 is responsible for gathering sufficient information from the suppliers 110, 112 and 114, from the purchaser entity 104, as well as from a 3rd party data source 106 with information on the purchaser 104, to verify identity details of the purchaser, determine eligibility of purchaser for any credit offer based on trade credit eligibility preferences provided by either the 3rd party data source 106 or the suppliers 110, 112 and 114. In various embodiments, automated credit eligibility and application platform 108 may also have proprietary data and eligibility preferences that impact the types of credit offers being displayed for each purchaser.

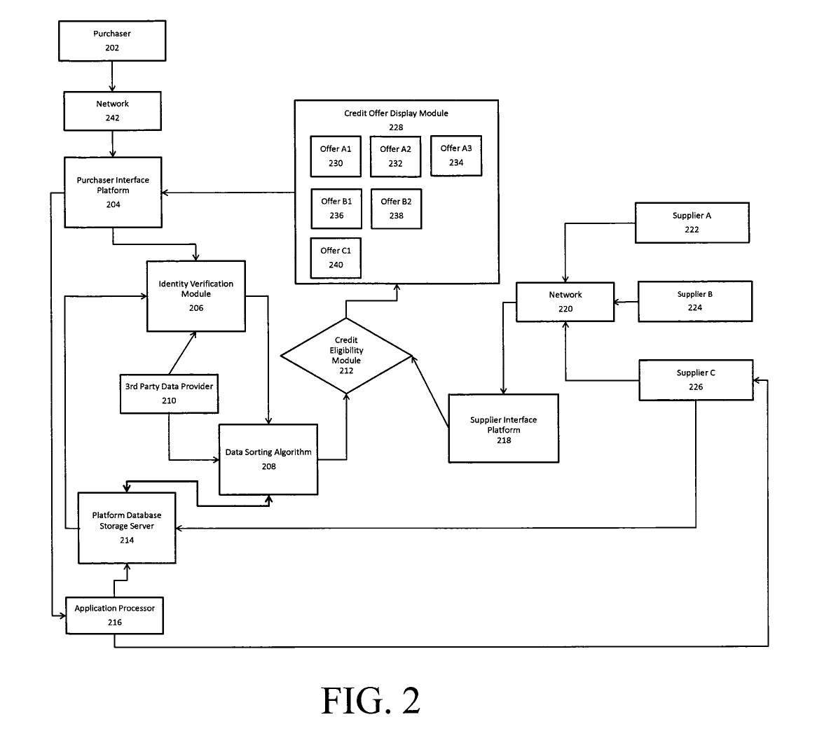

As understood by those skilled in the art in view of the description of FIG. 1A as well as the hereinbelow description of FIGS. 2 through 10, embodiments of the invention may be implemented by a system comprising one or more programmable digital computers. FIG. 1B depicts an example of such a system 100 comprising computer systems 101, 103, 160, 170, 172, 174, and 180 each communicably coupled to a network 142, which may comprise one or more public and/or private networks, including one or more LANS, WANS, intranets, the Internet, and other networks known in the art.

As shown, computer system (e.g., workstation) 101 includes at least one processor 111, such as, e.g., an Intel or Advanced Micro Devices microprocessor, coupled to a communications channel or bus 113. The computer system 101 further includes at least one input device 115 such as, e.g., a keyboard, mouse, touch pad or screen, or other selection or pointing device, at least one output device 116 such as, e.g., an electronic display device, at least one communications interface 118, at least one computer readable medium such as memory 122 (e.g., Random-Access Memory (RAM), which may store code (e.g., corresponding to processes) of operating system 132 and/or other programs 134) and data storage device 120 (e.g., a magnetic disk and/or an optical disk) accessed via storage device reader 136, each coupled to the communications channel 113. The communications interface 118 may be coupled to a network 142.

One skilled in the art will recognize that many variations of the system 101 are possible, e.g., the system 101 may include multiple channels or buses 113, various arrangements of data storage devices 120 and memory 122, as different units or combined units, one or more storage device readers 136, such as, e.g., a magnetic disk drive, magneto-optical drive, or optical disk drive, multiple components of a given type, e.g., processors 111, input devices 115, communications interfaces 118, etc. In some variations, computer system 101 may comprise a network (e.g., LAN, WAN, etc.) of devices (e.g., end-user workstations or PCs, one or more servers (e.g., server cluster), etc.), with this network communicably coupled with network 142. Those skilled in the art will also understand in view of the herein disclosure that computer system 101 is not limited to one or more personal computers, terminals, or workstations, nor limited to wired network connections, but may include any computing device that may communicably connect to network 142 (e.g., via wireless and/or wired connection(s); via a public or private network; via one or more devices, such as servers, routers, switches, hubs, etc.) and provide for one or more of transmitting and/or receiving information via network 142, receiving input and/or providing output via one or more user interfaces (e.g., keyboard/keypad (such as a touchscreen keyboard), a mouse, a display (such as an LCD display), etc.), and processing information received via network 142 and/or user interface, as may be required in accordance with embodiments of the present invention.

As understood by those skilled in the art, and in accordance with the foregoing and ensuing description herein, a computer readable medium may be any available medium that includes information that can be directly or indirectly accessed by, or otherwise made available to, a processor. By way of non-limiting example, computer readable media may comprise one or more of volatile and nonvolatile, removable and non-removable media implemented in any method or technology for storage of information such as computer readable instructions, data structures, program modules or other data. For example, computer readable media include any combination of RAM (e.g., DRAM), ROM, EEPROM, flash memory, magnetic RAM (MRAM), ferroelectric RAM (FRAM), or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer processor (e.g., processor 111).

In accordance with some embodiments, each of computer systems 103, 170, 172, and 174 may be independently configured, for example, as a server, workstation, personal computer or other end-user device, or as a network (e.g., LAN, WAN, etc.) of devices, such as in accordance with the foregoing description of computer system 101. Computer systems 101 and 103 may be associated with independent purchaser entities (e.g., computer system 101 may correspond to purchaser 104 of FIG. 1A) and computer systems/workstations 170, 172, 174 may be associated with independent supplier entities (e.g., corresponding to suppliers 110, 112, and 114 of FIG. 1A).

In one or more embodiments, computer systems 101, 103, 170, 172, and 174 are each communicably coupled via network 142 with trade credit computer system 160, which comprises an automated credit eligibility and application platform (e.g., corresponding to platform 108 of FIG. 1A), in accordance with some embodiments of the present invention. It will be understood by those skilled in the art that computer system 160 may be implemented as, or be part of, a multi-server environment having access to multiple databases to provide an automated credit eligibility and application platform (e.g. including geographically dispersed servers to provide service to geographically dispersed purchasers and/or geographically dispersed suppliers. Computer system 160 includes at least one computer (or processor) 144, which may comprise one or more host computers and/or server computers and/or one or more other computers (e.g. similar to computer system 101) performing host and/or server functions, including web server and/or application server functions. In one or more embodiments, at least one database 146 is accessed by the at least one computer 144. The at least one computer 144 may include components similar to those described for computer system 101 (e.g., input/output devices 149, memory 145, and storage 147), and may include other components as is well known in the computer arts. As shown, trade credit computer(s)/processor(s) 144 may be communicably coupled to network 142 via a device 150 (e.g., implemented as hardware and/or software and/or firmware) that may comprise a firewall and/or a gateway and/or one or more other communications interfaces. In some embodiments, device 150 may be implemented as a web server.

In accordance with some embodiments such as depicted in FIG. 1B, computer system 160 is also communicably coupled via network 142 to computer system/workstation 180, which may comprise any of one or more servers (e.g., server cluster), workstation, databases, networked devices, etc., for example, similar to the foregoing description of computer system 101 and/or 160. In some embodiments, computer system 180 may be associated with a 3rd party data source (e.g., corresponding to 3rd party data source 106 of FIG. 1A). Although FIGS. 1A and 1B each depict only one 3rd party data source, it will be understood in view of the herein description that some embodiments of the present invention may comprise more than one independent 3rd party data source communicably coupled to computer system 160 via network 142.

As will be further understood in view of the ensuing description, some embodiments of the present invention may implement an automated credit eligibility and application platform as a web-based application. For example, in some such embodiments, purchaser computer systems/workstations 101, 103 and supplier computer systems/workstations 170, 172, 174 may be implemented as clients associated with one or more servers implemented in trade credit system 160. In various embodiments, computer system 180 may also be implemented as a client associated with one or more servers implemented in trade credit system 160. The terms “client” and “server” may describe programs and running processes instead of or in addition to associated hardware and/or firmware corresponding to their application to computer systems described above. Generally, a client (e.g., software client) may consume information and/or computational services provided by a server (e.g., software server).

FIG. 2 is a detailed diagram of a computerized method for identifying a purchaser for an eligible credit offer and processing multiple applications made by the purchaser, in accordance with some embodiments of the present invention.

A purchaser 202 can be a borrower, a debtor or a customer in a goods, services or credit transaction, which may include, for example, trade credit from suppliers. Suppliers 222, 224 and 226 can be lenders, creditors or suppliers or partners in a goods, services or credit transaction, which may include, for example trade credit to customers. In some embodiments, suppliers 222, 224 and 226 may also be an external third party entity responsible, in whole or in part, for credit evaluation, screening, monitoring or underwriting roles for the credit offers extended on behalf of the suppliers, such as a credit underwriting outsourcing company or a private label net pay program manager.

In some embodiments, the purchaser 202 and suppliers 222, 224 and 226 are connected through electronic interface platforms 204 and 218, respectively, whereby the purchaser and the suppliers can register a business or personal entity on the platform. The identity of the entity is verified through an identity verification module 206 that compares the data input by the purchaser and the suppliers with the existing available data saved on the platform database storage server 214, or with data obtained from at least one 3rd party data provider 210 which may be, for example, a credit bureau, a ratings agency, a financial institution or a payment processing service. Purchaser interface platform 204 and supplier interface platform 218 are both accessible through networks 242 and 220. The network may represent, or be part of, for example, the Internet, an intranet, a LAN (Local Area Network), WAN (Wide Area Network) or MAN (Metropolitan Area Network), a frame relay connection, Advanced Intelligent Network (AIN) connection, a synchronous optical network (SONET) connection, a digital T1, T3, or E1 line, Digital Data Service (DDS) connection, DSL (Digital Subscriber Line) connection, an Ethernet connection, ISDN (Integrated Services Digital Network) line, a dial-up port such as a V.90, V.34 or V.34bis analog modem connection, a cable modem, an ATM (Asynchronous Transfer Mode) connection, FDDI (Fiber Distributed Data Interface) or CDDI (Copper Distributed Data Interface) connections, WAP (Wireless Application Protocol), GPRS (General Packet Radio Service), GSM (Global System for Mobile Communication) or CDMA (Code Division Multiple Access) radio frequency links, RS-232 serial connections, IEEE-1394 (Firewire) connections, USB (Universal Serial Bus) connections or other wired or wireless, digital or analog interface or connections.

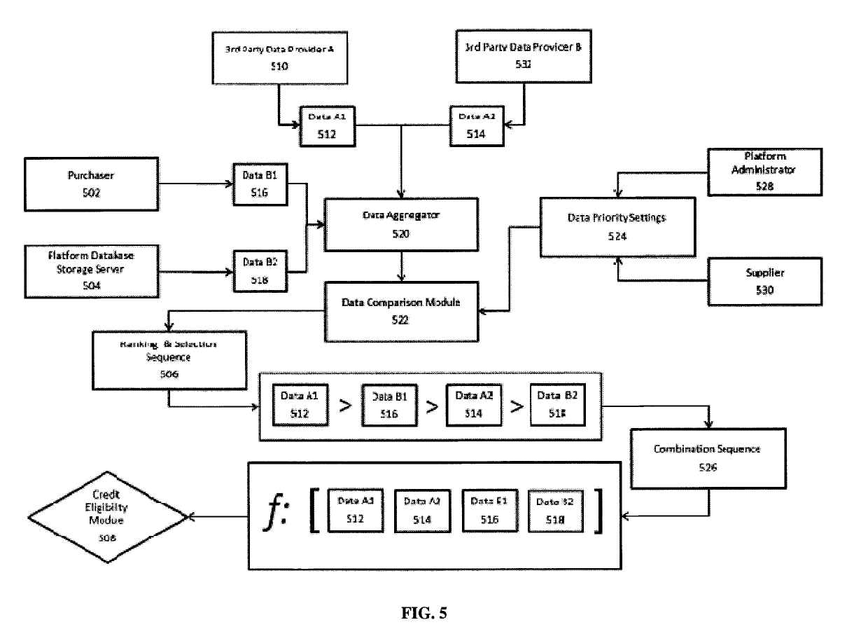

In some embodiments, data gathering processes are monitored and controlled by data sorting algorithm 208, further described in FIG. 5, that is responsible for obtaining different sets of data from different sources, including the purchaser 202, the 3rd party data provider 210, the suppliers and the existing information stored in platform database storage server 214 and deciding on the right combination of data sets to send over to credit eligibility module 212 based on the data priority setting previously set by either the platform administrator or the external parties involved in information flow.

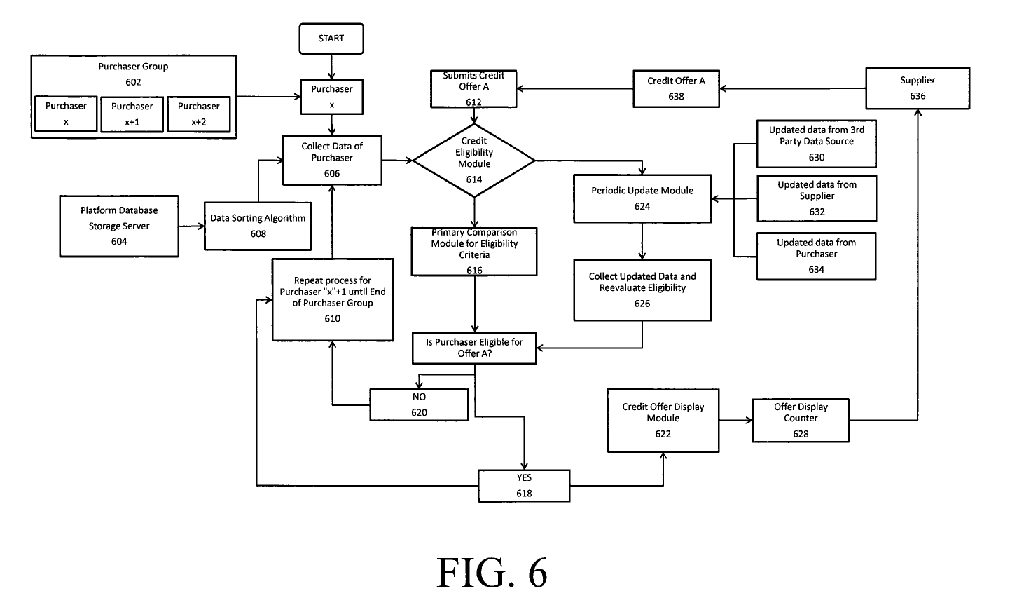

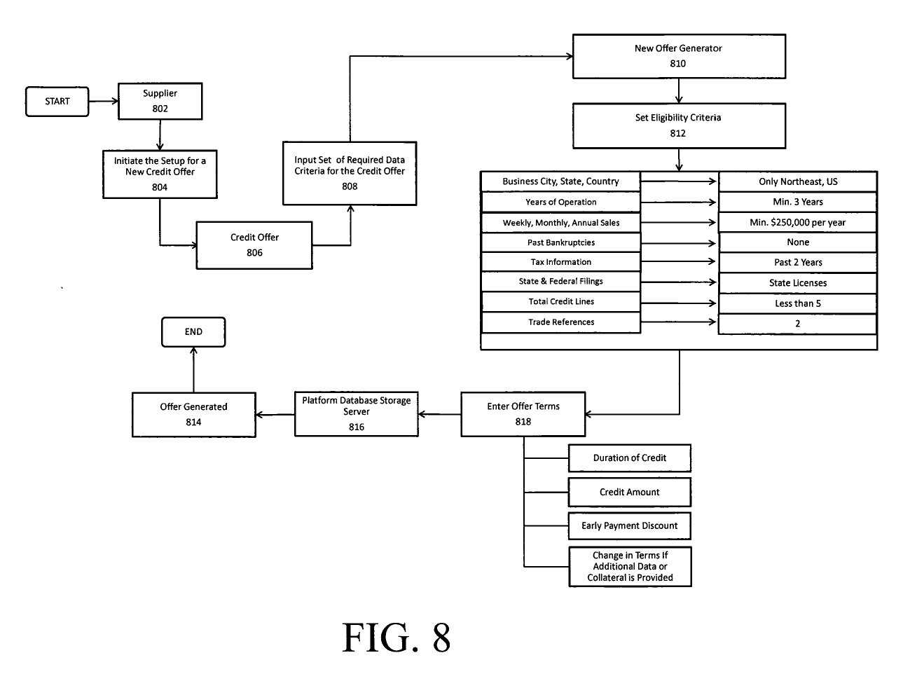

Supplier A 222, supplier B 224 and supplier C 226 submit, through a network 220 and via a supplier interface platform 218 credit offers that are generated through the process described in FIG. 8. In this embodiment, supplier A 222 generates three separate credit offers, Offer A1 230, offer A2 232 and offer A3 234. Supplier B 224 generates two separate credit offers, offer B1 236 and offer B2 238. Supplier C 226 generates a single credit offer, offer C1 240. Further in this embodiment, for credit offers A1 230, A2 232, A3 234, B1 236, B2 238, C1 240 a credit eligibility module 212 compares eligibility criteria submitted by the 3rd party data provider 210 and/or by the suppliers 222, 224 and 226 for any of these credit offers to the data on purchaser 202 collected by data sorting algorithm 208. Credit eligibility criteria include any criteria used during a credit approval process by a creditor, for example a trade credit supplier, to evaluate the credit application or the general creditworthiness of a purchaser. For example, credit eligibility criteria may comprise one or more of industry specific information about the company, geographic information, operational data, including years in operation, financial performance, past credit history, past payment performance, existing and past lines of credit, information regarding the outstanding debt of the business entity, its owners or partners, employees, existing or past trade references, credit scores from one or more credit bureaus, ratings agencies, identification numbers assigned by 3rd parties, such as D-U-N-S number, social security number, employer identification and federal tax identification numbers. A detailed description of a credit eligibility module according to some embodiments is further illustrated in FIG. 6.

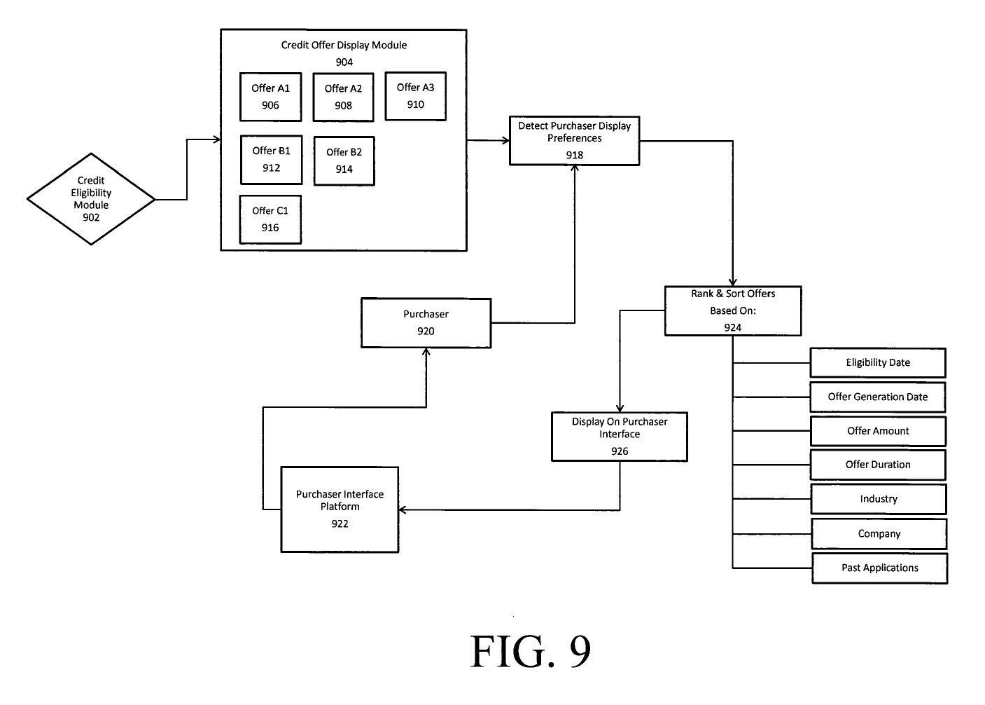

Based on the output from credit eligibility module 212 about the match between credit deals and the purchaser 202, credit offer display module 228 is responsible for displaying credit offers to the purchaser based on purchaser 202's eligibility level. In some embodiments, credit offer display module 228 may display all credit offers with additional information on certain eligibility benchmarks along with the offers. Some embodiments may display credit offers in multiple segments divided by eligibility status. A detailed description of credit offer display module 228 according to some embodiments is presented in FIG. 9.

In some embodiments, the purchaser has the ability to apply for available credit offers through the purchaser interface platform 204. The application process is monitored and controlled by the application processor 216 that receives the credit application order from the purchaser and transmits the application to the relevant supplier that originated the credit offer. The credit application order may be a single step process, such as a single click on the credit offer through the purchaser interface platform 204. Alternatively or additionally, application process for the credit offers may be automated and may not require any input from a purchaser to initiate or submit applications for credit offers.

Various embodiments of the process may replace the purchaser interface platform with a non-web based interface, an automated or electronic medium, a mobile device, or simple manual data population methods.

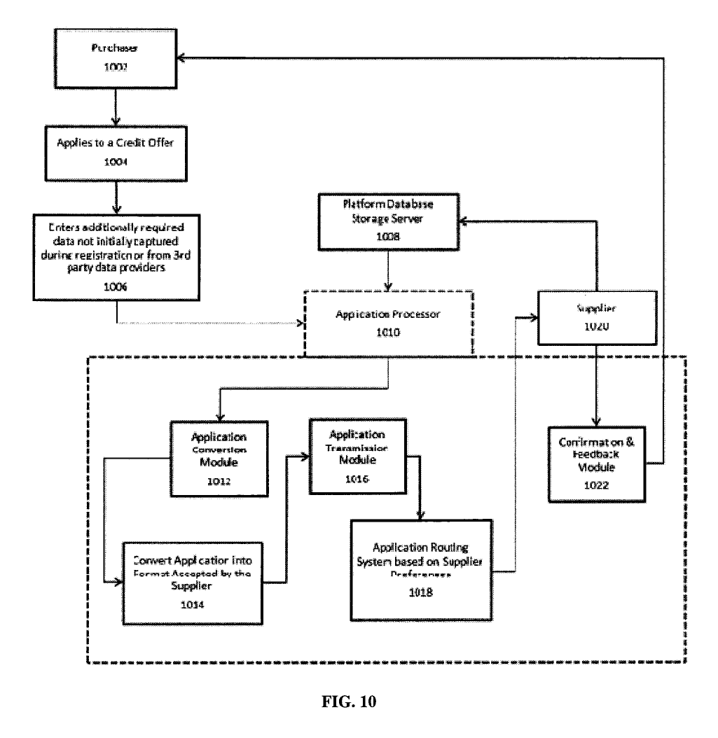

The application processor 216 also sends the application data to platform database storage server 214, to be saved and potentially later recalled for monitoring, analysis, bookkeeping or marketing purposes. A detailed description of an application processor according to some embodiments is further illustrated in FIG. 10.

Various embodiments may allow the purchaser to upload information directly from the purchaser's accounting systems and software.

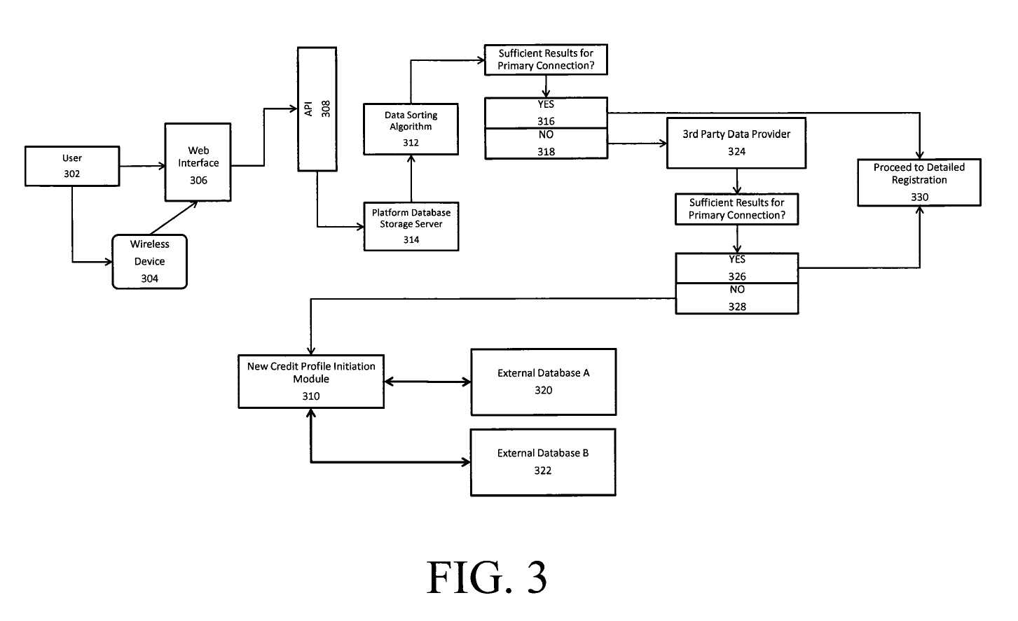

Primary connection method for a user (e.g., a purchaser in this illustrative embodiment) according to some embodiments is further illustrated in detail in FIG. 3, where a computerized method for identifying and initial registering of the user on the platform is explained. The process is initiated by a user 302, who accesses the web interface 306 of the platform either through a wired connection or through a wireless connection device 304. In this example, a data sorting algorithm 312 then compares the results with existing data on the platform database storage server 314. This data can be stored on an external server (e.g., over an online platform) and/or within an internal database storage server. In some embodiments, the platform database storage server 314 can be a continuous data pool without storage capacity, an internal server or a number of data sources that the data sorting algorithm 312 connects, for example through an application programming interface (API) 308.

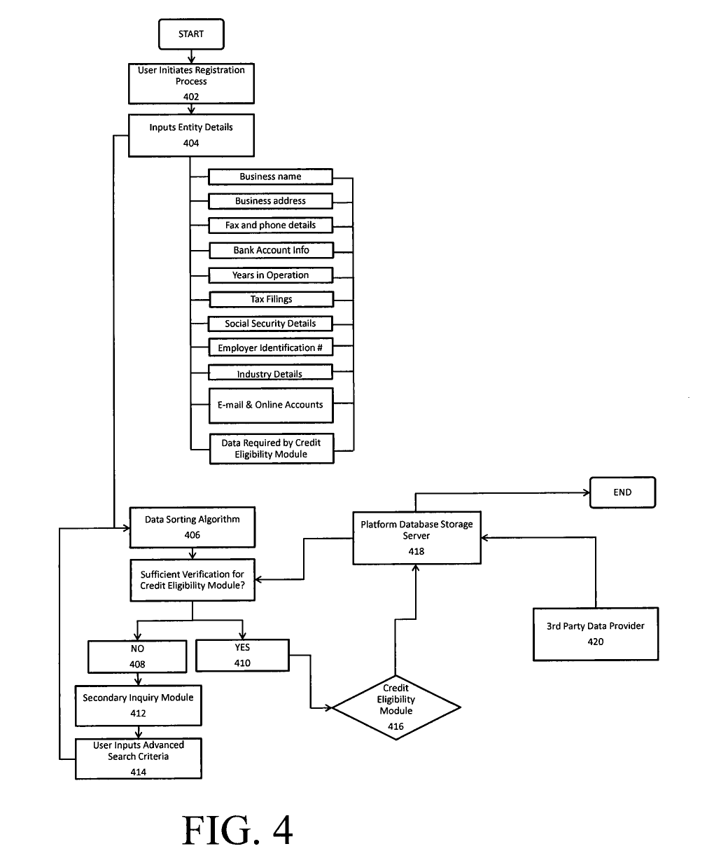

If there are sufficient results to identify and register the user in state 316, data sorting algorithm directs the user to proceed to registration at step 330, further explained in FIG. 4. If the results obtained from the platform database storage server are not sufficient for identification and initial registration as in step 318, data sorting algorithm 312 will connect to external sources of information, in this example a 3rd party data provider 324 to obtain sufficient data for identification and initial registration. If the response is sufficient for identification and initial registration as in step 326, data sorting algorithm 312 directs the user to proceed to detailed registration at step 330. If the response from 3rd party data provider 324 is not sufficient as in step 328, new credit profile initiation module 310 directs the user 302 to generate a new profile with external databases A and B, 320 and 322, respectively. In some embodiments, external databases may be one or more 3rd party data providers, for example a credit bureau, a ratings agency, a financial institution or an electronic data management system that is either standalone or connected to a software application. In some embodiments external databases may be a single database.

In some embodiments, new credit profile initiation module may be a simple link to an external database or a user interface that collects information that gets transmitted to external databases. In various embodiments, external databases may be internal.

Other platform architectures that may be implemented according to some embodiments may decide to keep the data at an external storage server instead of the platform database storage server 314 or through an online network that does not require an offline server.

The computerized step by step registration and identity verification process for the purchaser according to some embodiments is further illustrated in FIG. 4 where the user initiates the registration process at step 402 by either accessing the platform interface which may be assumed is present, or through a wired or wireless connection, with or without the assistance of another program, software or algorithm. The user then inputs entity contact details 404, which may include, for example, business name, business address, telephone and fax details, business owner's personal details and other data required by credit eligibility module. Input information is compared with existing records and available information from platform database storage server 418. Data sorting algorithm 406 opens a new inquiry by sending the input data to a 3rd party data provider 420, in one embodiment for example, a credit bureau, a government agency or a private information agency, either by sending the input information in part or in its entirety. 3rd party data provider responds with available results, which are then stored in platform database storage server 418. If the response is not sufficient as in step 408, the secondary inquiry module 412 prompts the user to input further information in order to better locate and identify the business or personal entity. In some embodiments, data sorting algorithm 406 and secondary inquiry module 412 can be combined into a single unit. The user then inputs the advanced search criteria 414, which is then compared with available information, either internally on platform database storage server 418 or externally from 3rd party data provider 420 for verification, identification or confirmation purposes. Alternatively or additionally, a user may not have to input advanced search criteria; instead, the secondary inquiry module 412 may connect to a third party to gather the information required in this process. If there is sufficient information about the user at step 410, the user's information is then transferred over to the credit eligibility module 416. In some embodiments, the identification and verification process may refer to individuals rather than or in addition to business entities. The user may be the purchaser or an employee, consultant, partner or associate of the purchaser, or another entity that is registering on the platform on behalf of or with the authorization of the purchaser.

In some embodiments, credit eligibility module 416 may replace data sorting algorithm 406, and vice versa.

FIG. 5 is a flow chart describing a computerized method for data selection, sorting, ranking and combination process for credit criteria on the platform, in accordance with some embodiments.

A data aggregator 520 collects packets of data A1, A2, B1 and B2, referenced respectively as 512, 514, 516 and 518, as required by the credit eligibility module 508, or for registration, identification and verification purposes, from a number of sources, including, for example, the purchaser 502, platform database storage server 504 or 3rd party data providers A and B, referenced respectively as 510 and 532.

In some embodiments, data packets A1, A2, B1 and B2 may be identical or they may vary depending on the source. In various embodiments, the data aggregator 520 may not be able to gather data from all the sources. The data packets represent information that is gathered to formulate a final ranking, selection and combination sequence using all the available data, which is later sent over to the credit eligibility module 508.

Data aggregator 520 is responsible for trying to collect all the available data that may be necessary during any one of the identification, verification, registration, or credit eligibility evaluation processes.

Once all the data that is available to data aggregator 520 is collected, data comparison module 522 is initiated, whereby the collected data is ranked, sorted and combined depending on the priority settings 524, a collection of preferences about, for example, how to rank every packet of data, how to combine different packets of data that belong to the same criterion, how to prioritize data based on importance, weight, average or past accuracy. Data priority settings may be provided either by a platform administrator 528, an entity with control over administrative settings over the data sorting, ranking and combination process, or by the supplier 530, depending on the supplier's preferences, for example, about data sources and combinations.

Once data comparison module 522 receives the notice that all available packets of data have been collected by the data aggregator 520, data comparison module 522 process begins, with two main components. Ranking and selection sequence 506 is responsible for determining the relative priority levels among data packets pertaining to the same criterion. For example, Data A1 512 from 3rd party data provider A 510 may state that the purchaser 502 has been in operation for 3 years, and Data A2 from 3rd party data provider B 532 may state that the purchaser 502 has been in operation for 4 years; if data priority settings have been established in a way that gives data packets from 3rd party data provider A 510 seniority over data packets from 3rd party data provider B 532, ranking and selection sequence will rely on Data A1 512 as the primary data packet, as long as Data A1 512 is available.

In cases where all sources provide different data packets about the same criterion, ranking and selection sequence 506 is responsible to provide a seniority that is based on previously established data priority settings 524. For instance, by way of example for purposes of clarity of exposition, in the illustrative embodiment herein discussed, data priority settings 524 are established to rank the data packets in the following order: Data A1, Data B1, Data A2, Data B2, 512, 516, 514 and 518, respectively.

The second component, according to some embodiments, involves combination sequence 526, whereby the data packets 512, 514, 516 and 518 undergo a functional operation that is determined again by the data priority settings 524. The function operation might be, for example, providing an average of all available data packets to credit eligibility module 508 as the final data packet, or eliminating the data packet that has most recently been updated and providing the average of the remaining set as the final data packet. As data comparison module 522 completes processing data, final data packets are sent to the credit eligibility module 508.

Credit eligibility module, further explained in detail in FIG. 6 according to some embodiments is an automated decision-mechanism that determines the eligibility of a purchaser in a group of purchasers for a credit offer generated by a supplier. In some embodiments such as that herein described, credit eligibility module 614 is responsible for analyzing the data available about purchaser x that is part of a purchaser group 602 to determine the eligibility of purchaser x for a certain credit offer A 638 by comparing the available data about purchaser x to the eligibility criteria submitted by the supplier 636 with credit offer A. Purchaser group 602 may represent, for example, the group of all purchasers credit eligibility module 614 may collect sufficient data to determine eligibility. Credit eligibility module 614 can be activated by a number of events, including, for example, when a new credit offer is submitted, when a new purchaser needs to be evaluated or when any one of the data packets that provide information about any one of the eligibility criteria, further described in FIG. 5, is updated.

In some embodiments such as that presently described, supplier 636 generated credit offer 638 and submits it in step 612. Eligibility module 614 begins the process by collecting data about the purchaser x in step 606 to be used to determine eligibility for credit offer A 638. Step 612 and step 606 may occur in different order in various implementations. The data collection about the purchaser x at step 606 may take place from a number of different sources, including the purchaser x itself, accounting software and tools of the purchaser, and the data sorting algorithm 608 which, in some embodiments, may also obtain data from the platform database storage server 604.

The collected data is then input into the credit eligibility module 614, which, if the purchaser x is being processed for eligibility for the first time, processes the data through primary comparison module 616 for eligibility criteria. Step 616 determines initial eligibility of purchaser x for credit offer A. If the purchaser x is not eligible, as in step 620, credit eligibility module 614 continues the process with the next available purchaser in step 610, in this embodiment purchaser x+1, within purchaser group 602. If the purchaser x is eligible, as in step 618, credit eligibility module 614 notifies the credit offer display module 622, further described in FIG. 9, about the eligible purchaser x and proceeds to determine eligibility for the next purchaser in step 610, in this embodiment, purchaser x+1, followed by purchaser x+2. Should purchaser x not be approved for the trade credit offer, this iterative process may be conducted on the purchaser x itself until purchaser x indeed becomes eligible for the trade credit offer.

Some embodiments such as that presently described may also have an offer display counter 628 that provides feedback and statistical data back to the supplier 636 about the eligible and non-eligible purchasers regarding credit offer A 638. In some embodiments credit offer display module 628 may also notify the purchaser x if purchaser has been approved or rejected for the trade credit offer and the reason. Additional potential offers contingent upon meeting certain minimum criteria may also be displayed to purchaser x.

The periodic update module 624 within the credit eligibility module 614 is responsible for determining eligibility of purchasers for certain credit offers in cases where there is a change on purchaser data or eligibility criteria either in the form of an update from a 3rd party data source 630, an update from supplier 632 or an update from purchaser 634. In case of any update or modification received through any one of the data sources, periodic update module 624 collects updated data and reevaluates eligibility of purchaser x for credit offer A 638 at step 626.

In some embodiments, credit eligibility of purchasers in purchaser group 602 may be determined simultaneously without running the credit eligibility module 614 process multiple times.

Also in some embodiments, primary comparison module 616 may be combined with periodic update module 624 or these two modules may be combined with the credit eligibility module 614 and be represented as a single unit.

Other embodiments may combine credit eligibility module 614 with data sorting algorithm 608 into a single unit.

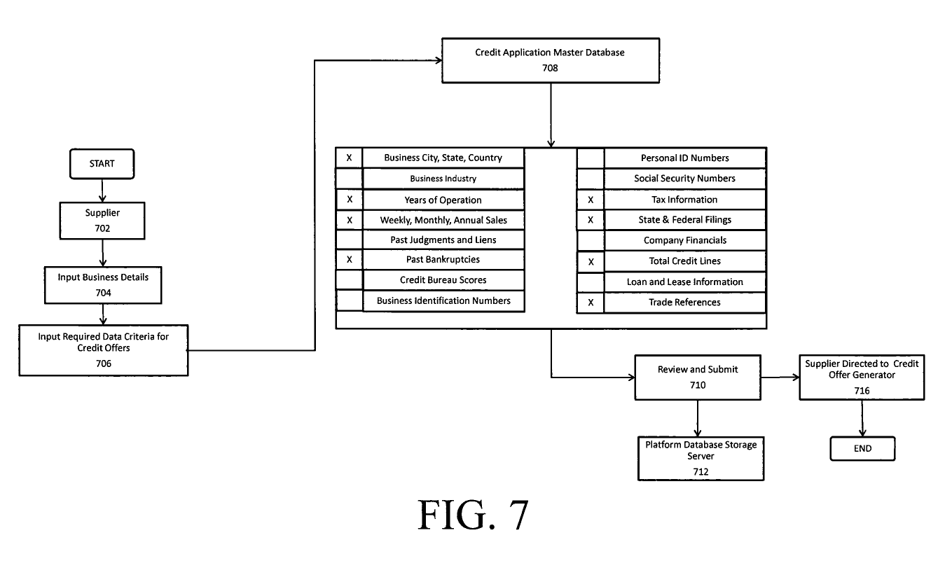

FIG. 7 is a schematic representation of the computerized system responsible for primary registration and initial setup for a supplier according to some embodiments. Supplier 702 registers by inputting business details 704, which may include, for example, the business name, address, phone number, fax details, DBA names, banks account information, 3rd party identification numbers, titles or codes such as social security number, D-U-N-S number, federal employer or tax identification numbers or other credit bureau identification codes, e-mail or online account details. The initial entity registration may be completed by supplier, or any affiliate, advisor, partner, underwriter or an employee of the supplier entity or by a third party that is registering to originate credit offers on behalf of the supplier.

Following registration, the supplier inputs the required data criteria for credit offers in step 706 from among a list of other data criteria on a credit application master database, which may include data criteria such as business, city, state, country, business industry, years of operation, weekly, monthly or annual sales, past judgments or and liens, past bankruptcies, credit bureau scores either for business entity or for individuals, business identification numbers, personal identification numbers, social security numbers, tax information, state and federal filings, company financials, total credit lines, loan and lease information about the business or the individual representing the business, and trade references.

After selecting the required data criteria from application master database 708, supplier 702 reviews and submits the selection in step 710. Submitted selection is stored in platform database storage server 712 while the supplier is directed to the credit offer generator 716 to generate credit offers.

In various embodiments, credit offer generator 716 may be combined with step 706 where supplier 702 inputs required data criteria for credit offers. Also, some embodiments may automatically populate the credit application master database 708 on behalf of the supplier 702 without any input from the supplier (e.g., without manual input of data and/or without manual input of a command to invoke population of the credit application master database 708).

FIG. 8 is a flow chart illustrating credit offer setup process for the supplier according to some embodiments. As shown, in such illustrative embodiments, supplier 802 initiates the setup process for a new credit offer 806 in step 804 by inputting the set of required data criteria 808 for the credit offer. These may be a subset of the required data criteria input during registration process described in FIG. 7 or the two sets of data criteria may be identical.

Once step 808 is complete, the set of required data criteria 808 are sent to the new offer generator 810, where the supplier 802 is prompted to set eligibility criteria for the credit offer 806 in step 812. The eligibility criteria are required thresholds in order to become eligible for the credit offer 806. These thresholds may be, among other things, IF statements, AND statements, equalities or inequalities between numerical or non-numerical values imposed on the required data criteria previously submitted by the supplier. These thresholds may decide for example, that only purchasers that are operating in the northeast US, with at least 3 years of operating history, minimum annual sales of $250,000, no prior bankruptcies, two years of tax information, state licenses, less than five credit lines and that can provide 2 trade references may be eligible for credit offers. Once the eligibility criteria is set in step 812, the supplier 802 enters the offer terms 818 for the credit offer that include, for example, the duration of credit, the credit amount or a maximum cap on that amount, any early payment discount and potential change in terms if the purchaser provides additional data or collateral. The system then saves the credit offer, along with the offer terms into the platform database storage server 816 and generates the offer at 814, to be displayed for eligible purchasers, further described in FIG. 9.

In some embodiments, the offer terms may be alternatively or additionally input by a third party other than the supplier and/or may be determined by an auction system.

FIG. 9 is an overview of the electronic display module, as submitted by the supplier and viewed by the purchaser, according to some embodiments. Credit offer display module 904 receives all information produced by the credit eligibility module 902 regarding the eligibility of purchaser 902 to available credit offers, in this embodiment, for example, offer A1 906, offer A2 908, offer A3 910, offer B1 912, offer B2 914 and offer C1 916 for which purchaser 902 is determined to be eligible. Credit offer display module 904 then detects previously saved purchaser display preferences 918 and reorganizes the display rankings and sorting of the offers in step 924 based on a number of factors including, for example, eligibility date, offer generation date, offer amount, offer duration, industry, company or past credit applications of this particular purchaser or the particular supplier in this credit offer. Credit offer display module 904 then provides for displaying the sorted offers in step 926 on purchaser interface platform 922, which those skilled in the art will understand as providing for accessibility to the offers via one or more purchaser devices (e.g., PC, PDA, smartphone, or other mobile device) via one or more communication paths, networks, and/or protocols, etc. For example, in various embodiments the sorted offers may be pushed to the purchaser device(s) for display thereon (e.g., as an offer), and/or a notification may be sent to a purchaser device to indicate that sorted offer information is available and the user may then pull the sorted offers (e.g., by navigating using an internet browser on the same or different device that received the notification, possibly by selecting a hyperlink in the notification), and/or the purchaser may retrieve (e.g., pull) any available sorted offer information for display on the purchaser's device independently of receiving a notification that sorted offer(s) are available. In any such or other implementations, purchaser interface platform 922 provides for a purchaser to display on a purchaser device sorted offer(s) available to that purchaser, in accordance with some embodiments. Some illustrative forms of providing for display of the offer to the purchaser (e.g., providing a notification and/or the offer data) may include one or more of an e-mail (e.g., which may contain the sorted offer information, or may include an embedded hyperlink to the sorted offer information, etc.), an electronic voice message, and/or a text message.

In some embodiments, purchaser display preferences 918 may be automatically set by a third party or by an algorithm that screens other purchasers. Also in some embodiments, step 918, 924 and 926 may be combined into a single unit that detects purchaser display preferences, ranks and sorts offers and displays these offers on purchaser interface.

In some embodiments, credit offer display module 904 may be additionally or alternatively structured to process a single offer at a time instead of multiple offers.

Some embodiments may combine all the components of credit offer display module 904 with credit eligibility module 902.

FIG. 10 is an illustration of a computerized method that manages the automatic application process for credit offers and post-application transmission, confirmation and feedback mechanism, in accordance with some embodiments. A purchaser 1002 applies to a credit offer in step 1004. Depending on the data elements required by the credit offer, the purchaser 1002 may be asked to input additional data elements that were not initially captured during registration or from 3rd party data providers. In some embodiments such as that herein described, once the purchaser enters the additional data elements in step 1006, the application processor 1010 initiates the process by transferring application data to application conversion module 1012 that is responsible for converting the purchaser's application into a format accepted by the supplier 1020, as in step 1014. Application that is processed through a conversion module is then transferred to the application transmission module 1016 that determines, in step 1018, the system with which the application will be routed to the supplier based on supplier preferences obtained through platform database storage server 1008. Transmission of application to the supplier 1020 may be either physical or electronic; may be a direct connection between electronic interface or may have to be processed manually without any electronic interference.

In some embodiments, once the application is routed to the supplier 1020, depending on supplier preferences, purchaser may receive a confirmation of receipt for the application and/or a feedback regarding the application via confirmation and feedback module 1022.

In some embodiments, application conversion module 1012, application transmission module 1016 and confirmation and feedback module 1022 may be combined into a single unit.

In various embodiments, application system may consist of a simple notification to the supplier 1020 that the purchaser 1002 applied for the credit offer 1004.

The present invention has been illustrated and described with respect to specific embodiments thereof, which embodiments are merely illustrative of the principles of the invention and are not intended to be exclusive or otherwise limiting embodiments. Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages.

For instance, systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Also, except to the extent necessary or inherent in the processes themselves, no particular order to steps or stages of methods or processes described in this disclosure, including the figures, is implied. In many cases the order of process steps may be varied, and illustrative steps may be combined, altered, or omitted, without changing the purpose, effect or import of the methods described. Additionally, those skilled in the art will understand in view of the herein described embodiments that many other configurations exist for determining eligibility of a purchaser for particular credit offers and facilitating credit applications between purchasers and suppliers through a multiple-offer display mechanism not specifically described herein but with which the present invention is applicable.

Therefore, the present invention should not be seen as limited to the particular embodiments described above, but rather, should be considered to have wide applicability with respect to general systems and methods for determining eligibility of a purchaser for particular credit offers and facilitating credit applications between purchasers and suppliers through a multiple-offer display mechanism. Moreover, one skilled in the art will readily appreciate that certain features of each embodiment described herein can be used in combination with methods and systems illustrated or described in other embodiments. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with the claims that follow.

The invention is further described by the following numbered paragraphs:

1. A method of facilitating the receipt by at least one purchaser of one or more credit offers by at least one supplier, the credit offers being associated with potential transactions involving the associated suppliers providing goods or services, or both, to the at least one purchaser, said method being implemented by a computer system comprising one or more processors operable in executing program code stored on at least one computer readable medium to cause the computer system to perform the method comprising:

the computer system receiving one or more credit offers associated with each of at least one supplier, each credit offer comprising credit eligibility criteria specified by the supplier associated with the credit offer, said credit eligibility criteria comprising at least one criterion that must be satisfied by a purchaser to qualify for the credit offer;

the computer system receiving respective purchaser-information from each of at least one purchaser, wherein the computer system is operative in attempting to ensure that the purchaser-information includes sufficient information to compare with all of the credit eligibility criteria of at least one of said credit offers;

the computer system analyzing at least the received purchaser-information and the received credit eligibility criteria to determine for each credit offer which, if any, of the at least one purchaser is eligible for the credit offer; and

the computer system providing for access by each purchaser to credit offer information that indicates the credit offers for which the purchaser is eligible.

2. The method according to paragraph 1, wherein the computer system is operative in attempting to ensure that the purchaser-information includes sufficient information to compare with all of the credit eligibility criteria of a plurality of said credit offers.

3. The method according to paragraph 1 or 2, wherein the computer system is operative in attempting to ensure that the purchaser-information includes sufficient information to compare with all of the credit eligibility criteria of the credit offers associated with different suppliers.

4. The method according to any one of paragraphs 1-3, wherein said computer system is operated by an entity independent of the purchasers and independent of the suppliers.

5. The method according to any one of paragraphs 1-4, further comprising:

the computer system receiving from a given one of the purchasers information indicating the given purchaser's selection of one or more credit offers for which the given purchaser is eligible;

the computer system generating on behalf of the given purchaser at least one credit application for each supplier associated with the one or more credit offers selected by the given purchaser, each credit application corresponding to at least one of the selected credit offers associated with a given supplier; and

the computer system sending on behalf of the given purchaser said at least one credit application to each of the suppliers associated with the one or more credit offers selected by the purchaser.

6. The method according to paragraph 5, further comprising the computer system sending to the given purchaser at least one electronic message indicating approval of one or more of the credit applications based on at least one electronic communication received by the computer system from one or more of the suppliers to which the at least one credit application was sent.

7. The method according to any one of paragraphs 1-6, further comprising the computer system generating on behalf of a given one of the purchasers a plurality of credit offer applications, each (i) corresponding to one or more credit offers for which the given purchaser is eligible and (ii) conforming to credit application requirements of the supplier associated with the one or more credit offers to which the credit application corresponds.

8. The method according to paragraph 6, further comprising the computer system sending at least one of the generated credit offer applications to the supplier associated with the one or more credit offers to which the credit application corresponds.

9. The method according to paragraph 8, further comprising the computer system sending to the given purchaser at least one electronic message indicating approval of one or more of the credit offer applications based on at least one electronic communication received by the computer system from one or more of the suppliers to which the at least one credit offer application was sent.

10. The method according to any one of paragraphs 1-9, wherein the computer system being operative in attempting to ensure that the purchaser-information includes sufficient information to compare with all of the credit eligibility criteria of at least one of said credit offers comprises the computer system sending to the at least one purchaser one or more notifications identifying one or more criteria to be satisfied to qualify for and/or be eligible for one or more credit offers.

11. The method according to paragraph 10, wherein the notifications are sent subject to the consent of the suppliers associated with the one or more criteria to be satisfied.

12. The method according to paragraph 8, wherein the computer system determines the criteria to be satisfied based on statistical data gathered from a pool of said purchasers.

13. The method according to any one of paragraphs 1-12, further comprising the computer system sending each of one or more purchasers a notification updating the purchaser as to the purchaser's business credit status.

14. The method according to any one of paragraphs 1-13, wherein said computer system providing for access by each purchaser to credit offer information comprises an interface providing for display to each purchaser of the credit offers for which the purchaser is eligible.

15. The method according to paragraph 14, wherein the interface provides for access initiated by the purchaser to display on an electronic device used by the purchaser credit offers for which the purchaser is eligible, without the purchaser having received a notification from the computer indicating eligibility for credit offers.

16. The method according to paragraph 14, wherein said computer system providing for access by each purchaser to credit offer information comprises the interface sending an electronic message capable of being displayed on an electronic device used by the purchaser.

17. The method according to any one of paragraphs 1-16, wherein the electronic message is a notification indicating that credit offer information is available.

18. The method according to paragraph 17, wherein the notification includes a hyperlink that, when selected, causes a browser on the electronic device to navigate to a page displaying one or more credit offers for which the purchaser is eligible.

19. The method according to paragraph 16, wherein the electronic message includes information specifying one or more credit offers for which the purchaser is eligible.

20. The method according to any one of paragraphs 1-19, wherein said computer system providing for access by each purchaser to credit offer information comprises sending an electronic message to each of the at least one purchaser determined to be eligible for at least one credit offer.

21. The method according to paragraph 20, wherein the electronic message is at least one of a voice message, an e-mail, and a text message.

22. The method according to any one of paragraphs 1-21, wherein said computer system providing for access to credit offer information comprises a voice response unit that provides for audio communication of the credit offers for which the purchaser is eligible.

23. The method according to any one of paragraphs 1-22, wherein receiving purchaser information includes receiving at least a portion of the purchaser information through a registration process prior to the computer system enabling the purchaser-information to be qualified for consideration in determining eligibility for any credit offers.

24. The method according to any one of paragraphs 1-23, wherein receiving purchaser information includes the computer system receiving at least a portion of the purchaser information independent of the time of the computer system receiving credit offer information.

25. The method according to any one of paragraphs 1-24, further comprising the computer system receiving from at least one third-party data source information concerning one or more of the purchasers, and wherein said analyzing to determine which of the at least one purchaser is eligible for the credit offer includes analyzing the information received from that at least one third-party data source.

26. The method according to paragraph 25, wherein the at least one third-party data source includes any of, or any combination of, at least one credit bureau, at least one ratings agency, at least one financial institution, and at least one payment processing service.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method of facilitating the receipt by at least one purchaser of one or more credit offers by at least one supplier, the credit offers being associated with potential transactions involving the associated suppliers providing goods or services, or both, to the at least one purchaser, said method being implemented by a computer system comprising one or more processors operable in executing program code stored on at least one computer readable medium to cause the computer system to perform the method comprising:
the computer system receiving one or more credit offers associated with each of at least one supplier, each credit offer comprising credit eligibility criteria specified by the supplier associated with the credit offer, said credit eligibility criteria comprising at least one criterion that must be satisfied by a purchaser to qualify for the credit offer;
the computer system receiving respective purchaser-information from each of at least one purchaser, wherein the computer system is operative in attempting to ensure that the purchaser-information includes sufficient information to compare with all of the credit eligibility criteria of at least one of said credit offers;
the computer system analyzing at least the received purchaser-information and the received credit eligibility criteria to determine for each credit offer which, if any, of the at least one purchaser is eligible for the credit offer; and
the computer system providing for access by each purchaser to credit offer information that indicates the credit offers for which the purchaser is eligible.

2. The method according to claim 1, wherein the computer system is operative in attempting to ensure that the purchaser-information includes sufficient information to compare with all of the credit eligibility criteria of a plurality of said credit offers.

3. The method according to claim 2, wherein the computer system is operative in attempting to ensure that the purchaser-information includes sufficient information to compare with all of the credit eligibility criteria of the credit offers associated with different suppliers.

4. The method according to claim 1, wherein said computer system is operated by an entity independent of the purchasers and independent of the suppliers.

5. The method according to claim 1, further comprising:
the computer system receiving from a given one of the purchasers information indicating the given purchaser's selection of one or more credit offers for which the given purchaser is eligible;
the computer system generating on behalf of the given purchaser at least one credit application for each supplier associated with the one or more credit offers selected by the given purchaser, each credit application corresponding to at least one of the selected credit offers associated with a given supplier; and
the computer system sending on behalf of the given purchaser said at least one credit application to each of the suppliers associated with the one or more credit offers selected by the purchaser.

6. The method according to claim 5, further comprising the computer system sending to the given purchaser at least one electronic message indicating approval of one or more of the credit applications based on at least one electronic communication received by the computer system from one or more of the suppliers to which the at least one credit application was sent.

7. The method according to claim 1, further comprising the computer system generating on behalf of a given one of the purchasers a plurality of credit offer applications, each (i) corresponding to one or more credit offers for which the given purchaser is eligible and (ii) conforming to credit application requirements of the supplier associated with the one or more credit offers to which the credit application corresponds.

8. The method according to claim 6, further comprising the computer system sending at least one of the generated credit offer applications to the supplier associated with the one or more credit offers to which the credit application corresponds.

9. The method according to claim 8, further comprising the computer system sending to the given purchaser at least one electronic message indicating approval of one or more of the credit offer applications based on at least one electronic communication received by the computer system from one or more of the suppliers to which the at least one credit offer application was sent.

10. The method according to claim 1, wherein the computer system being operative in attempting to ensure that the purchaser-information includes sufficient information to compare with all of the credit eligibility criteria of at least one of said credit offers comprises the computer system sending to the at least one purchaser one or more notifications identifying one or more criteria to be satisfied to qualify for and/or be eligible for one or more credit offers.

11. The method according to claim 10, wherein the notifications are sent subject to the consent of the suppliers associated with the one or more criteria to be satisfied.

12. The method according to claim 8, wherein the computer system determines the criteria to be satisfied based on statistical data gathered from a pool of said purchasers.

13. The method according to claim 1, further comprising the computer system sending each of one or more purchasers a notification updating the purchaser as to the purchaser's business credit status.

14. The method according to claim 1, wherein said computer system providing for access by each purchaser to credit offer information comprises an interface providing for display to each purchaser of the credit offers for which the purchaser is eligible.

15. The method according to claim 14, wherein the interface provides for access initiated by the purchaser to display on an electronic device used by the purchaser credit offers for which the purchaser is eligible, without the purchaser having received a notification from the computer indicating eligibility for credit offers.

16. The method according to claim 14, wherein said computer system providing for access by each purchaser to credit offer information comprises the interface sending an electronic message capable of being displayed on an electronic device used by the purchaser.

17. The method according to claim 16, wherein the electronic message is a notification indicating that credit offer information is available.

18. The method according to claim 17, wherein the notification includes a hyperlink that, when selected, causes a browser on the electronic device to navigate to a page displaying one or more credit offers for which the purchaser is eligible.

19. The method according to claim 16, wherein the electronic message includes information specifying one or more credit offers for which the purchaser is eligible.

20. The method according to claim 1, wherein said computer system providing for access by each purchaser to credit offer information comprises sending an electronic message to each of the at least one purchaser determined to be eligible for at least one credit offer.

21. The method according to claim 20, wherein the electronic message is at least one of a voice message, an e-mail, and a text message.

22. The method according to claim 1, wherein said computer system providing for access to credit offer information comprises a voice response unit that provides for audio communication of the credit offers for which the purchaser is eligible.

23. The method according to claim 1, wherein receiving purchaser information includes receiving at least a portion of the purchaser information through a registration process prior to the computer system enabling the purchaser-information to be qualified for consideration in determining eligibility for any credit offers.

24. The method according to claim 1, wherein receiving purchaser information includes the computer system receiving at least a portion of the purchaser information independent of the time of the computer system receiving credit offer information.

25. The method according to claim 1, further comprising the computer system receiving from at least one third-party data source information concerning one or more of the purchasers, and wherein said analyzing to determine which of the at least one purchaser is eligible for the credit offer includes analyzing the information received from that at least one third-party data source.

26. The method according to claim 25, wherein the at least one third-party data source includes any of, or any combination of, at least one credit bureau, at least one ratings agency, at least one financial institution, and at least one payment processing service.
